(19) United States
(12) Patent Application Publication
(10) Pub. No.: US 2011/0034130 A1
(43) Pub. Date: Feb. 10, 2011

(54) METHOD AND SYSTEM FOR DETERMINING TOTAL ISOTROPIC SENSITIVITY USING RSSI MEASUREMENTS FOR WIMAX DEVICE CERTIFICATION

(76) Inventors: Anand S. Konanur, Sunnyvale, CA (US); Ulun Karacaoglu, San Diego, CA (US); Roni Abiri, Raanana (IL); Sandeep Gupta, San Francisco, CA (US); Songnan Yang, San Jose, CA (US)

Correspondence Address: SCHWEGMAN, LUNDBERG & WOESSNER, P.A., P.O. BOX 2938, MINNEAPOLIS, MN, 55402, US

(21) Appl. No.: 12/536,004

(22) Filed: Aug. 5, 2009

(51) Int. Cl. H04B 17/00

(52) U.S. Cl. 455/67.11

(57) ABSTRACT

Embodiments of a system and method of determining total isotropic sensitivity (TIS) of a wireless broadband client device are described herein. A received signal strength indicator (RSSI) reported at an embedded radio module of the device is logged for each of a plurality of antenna polarizations and for each of a plurality of platform orientations. A single point measurement of module sensitivity is performed at a reference orientation and polarization the transmit antenna. The TIS is calculated as a correction to the single point measurement of module sensitivity. A correction factor to correct the TIS may be based on the difference between an average of the logged RSSIs and an RSSI at the reference orientation and polarization of the transmit antenna.

### TECHNICAL FIELD

Embodiments pertain to radiated performance testing of broadband wireless client devices. Some embodiments relate to measurements of radiated sensitivity, such as total isotropic sensitivity (TIS), for certification by a standards body. Some embodiments relate to testing the average radiated sensitivity of broadband wireless client devices, such as WiMAX devices, in accordance with procedures of an organization such as the WiMAX forum or the CTIA. Some embodiments relate to the derivation of TIS using received signal-strength indicators (RSSIs).

### BACKGROUND

Several current and emerging wireless broadband wireless standards (e.g., the WiMAX, the WCDMA, the 3G HSPA, and the LTE standards) have radiated performance testing as a component in securing operator and/or standard governing body certification. Currently, the measurement of radiated sensitivity of broadband wireless client devices is the most time consuming of the certification tests and can be a significant cost adder and lead to time consuming iterations to bringing broadband wireless client devices (e.g., notebook computers, netbooks, handhelds, dongles) to market.

The WiMAX Forum and the CTIA (the wireless association), for example, require testing the average radiated sensitivity of broadband wireless client devices. This testing, referred to as TIS, includes measuring the sensitivity of the client system (e.g., module and platform) for many different platform orientations at different antenna polarizations for each frequency band and for each frequency profile. This testing is time consuming (e.g., approximately 6-7 hrs per frequency band per frequency profile) because among other things, there can be up to 144 or more platform orientations. With the worldwide adoption of broadband wireless standards, several profiles are usually covered leading to significant increases in test times. Since certification costs are directly related to total test time, the measurement of TIS has a large cost and time impact to getting wireless broadband client devices certified and into the market on time.

Thus there are general needs for systems and methods for reducing certification costs and certification test times of broadband wireless client devices. There are also general needs for systems and methods for determining the TIS of broadband wireless client devices in a more cost effective manner. What is also needed is a system and method to significantly ease the certification process for WiMAX, the WCDMA, the 3G HSPA, and the LTE devices, while providing scalability to allow the tests can be applied across multiple frequency bands and standards profiles without prohibitive test-time increases.

### BRIEF DESCRIPTION OF THE DRAWINGS

FIG. 1 illustrates a test setup system for determining total isotropic sensitivity (TIS) in accordance with some embodiments;

FIG. 2 illustrates received signal-strength indicators (RSSIs) and effective isotropic sensitivity (EIS) measurements in accordance with some embodiments;

FIG. 3 illustrates an EIS pattern, the measured and estimated TIS, and the RSSIs in accordance with some embodiments;

FIG. 4 illustrates an RSSI pattern and an average RSSI in accordance with some embodiments; and

FIG. 5 is a procedure for determining TIS in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

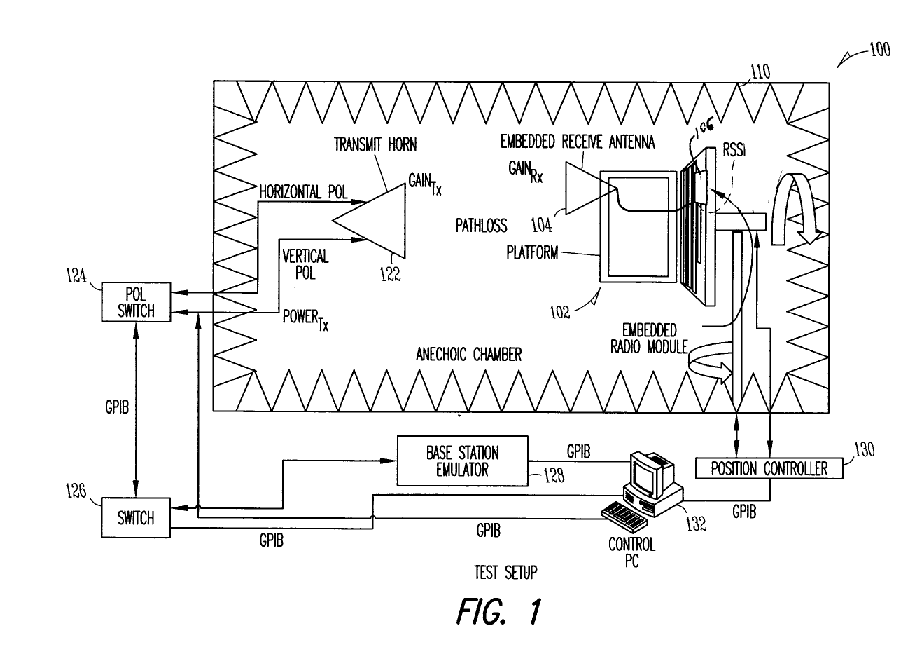

FIG. 1 illustrates a test setup system for determining total isotropic sensitivity (TIS) in accordance with some embodiments. Test setup system 100 may be suitable for testing a wireless broadband client device 102. Test setup system 100 includes anechoic chamber 110, transmit horn antenna 122, polarization (POL) switch 124, TX/RX switch 126, base station emulator 128, position controller 130, and control computer (PC) 132. A general-purpose-interface bus (GPIB) or local-area network (LAN) connections, for example, may be used between the control computer 132 and the various elements of the test setup system 100. For testing purposes, the wireless broadband client device 102 may be considered a platform and may include one or more device antennas 104 embedded therein and an embedded radio module 106.

In accordance with embodiments, the test setup system 100 may be used to determine the TIS of the wireless broadband client device 102. In these embodiments, a received signal strength indicator (RSSI) reported at the embedded radio module 106 is logged for each of a plurality of polarizations of transmit antenna 122 and for each of a plurality of orientations of the platform. In accordance with embodiments, a single point measurement of module sensitivity may be performed at a reference orientation of the platform and a single polarization of the transmit antenna 122. The TIS may be calculated as a correction to the single point measurement of module sensitivity. A correction factor to correct the TIS may be based on a difference between an average of the logged RSSI measurements and an RSSI at the reference orientation and polarization. As a result of this technique, a six-fold reduction in test time may be achieved for determination of radiated sensitivity. These embodiments are described in more detail below.

In some embodiments, the single point measurement of module sensitivity performed at the reference orientation and polarization may include stepping down the transmit power level of the base station emulator 128. The packet-error-rate (PER) at each of the stepped-down transmit power levels is monitored until the PER falls below a predetermined threshold. Conventionally, these are done at each platform orientation and at each transmit antenna polarization. The use of a single reference orientation and a single antenna polarization results in a substantial reduction in test time and costs associated with certifications.

In some embodiments, the reference orientation and reference antenna polarization are selected from a highest of the logged RSSIs for a single polarization of the transmit antenna 122. The base station emulator 128 may provide at a fixed high transmit power for measuring the logged RSSIs. The logging of the RSSIs, among other things, captures gain variation of the device antenna 104. In some embodiments, additional accuracy maybe obtained by monitoring RSSI with averaging over a greater number of frames and/or using multiple measurements.

The wireless broadband client device 102 may be configured to operate in accordance with one or more frequency bands and/or standards profiles including a WiMAX standards profile, a WCDMA standards profile, a 3G HSPA standards profile, and a LTE standards profile. In some embodiments, the logging of RSSIs, the performing the single point measurement of module sensitivity, and the calculating the TIS may be repeated for each of a plurality of frequency bands. Since only a single point measurement of module sensitivity is performed for each frequency band, the time-consuming search for module sensitivity at each transmit antenna polarization and each platform orientation that is conventionally done is eliminated. Rather than stepping down the transmit power level of the base station emulator 128 and monitoring the PER at each of the transmit power levels until the PER falls below a predetermine threshold at each polarization and each orientation, embodiments of the present invention allow this to be done at a single point while the RSSI is recorded at the other points. These embodiments are discussed in more detail below.

In some embodiments, an effective isotropic sensitivity (EIS) for any of the platform orientations may be estimated by applying another correction factor to the single point measurement of module sensitivity and the RSSIs. These embodiments are discussed in more detail below.

In some embodiments, embedded radio module 106 may be configured to communicate orthogonal frequency division multiplexed (OFDM) communication signals which may comprise a plurality of orthogonal subcarriers. In some of these multicarrier embodiments, wireless broadband client device 102 may be broadband wireless access (BWA) network communication station, such as a Worldwide Interoperability for Microwave Access (WiMAX) communication station. In some other broadband multicarrier embodiments, wireless broadband client device 102 may be a 3rd Generation Partnership Project (3GPP) Universal Terrestrial Radio Access Network (UTRAN) Long-Term-Evolution (LTE) communication station, although the scope of the invention is not limited in this respect. In these broadband multicarrier embodiments, wireless broadband client device 102 may be configured to communicate in accordance with an orthogonal frequency division multiple access (OFDMA) technique.

In some embodiments, wireless broadband client device 102 may be configured to communicate in accordance with specific communication standards, such as the Institute of Electrical and Electronics Engineers (IEEE) standards including the IEEE 802.16-2004 and the IEEE 802.16(e) standards for wireless metropolitan area networks (WMANs) including variations and evolutions thereof, although the scope of the invention is not limited in this respect. In some embodiments, wireless broadband client device 102 may be configured to communicate in accordance with the Universal Terrestrial Radio Access Network (UTRAN) LTE communication standards. For more information with respect to the IEEE 802.16 standards, please refer to “IEEE Standards for Information Technology—Telecommunications and Information Exchange between Systems”—Metropolitan Area Networks—Specific Requirements—Part 16: “Air Interface for Fixed Broadband Wireless Access Systems,” May 2005 and related amendments/versions. For more information with respect to UTRAN LTE standards, see the 3rd Generation Partnership Project (3GPP) standards for UTRAN-LTE, release 8, March 2008, including variations and evolutions thereof.

In some other embodiments, wireless broadband client device 102 may be configured to communicate using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, wireless broadband client device 102 may be a personal digital assistant (PDA), a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

Device antenna 104 may comprise one or more directional or omnidirectional antennas, including, for example, dipole antennas, monopole antennas, patch antennas, loop antennas, microstrip antennas, inverted F-antennas or other types of antennas suitable for transmission of RF signals. In some multiple-input multiple-output (MIMO) embodiments, two or more device antennas 104 may be used. In some embodiments, instead of two or more antennas, a single antenna with multiple apertures may be used. In these embodiments, each aperture may be considered a separate antenna. In some MIMO embodiments, two or more device antennas 104 may be effectively separated to take advantage of spatial diversity and the different channel characteristics that may result.

Conventionally, the TIS of a platform is calculated by performing a full sensitivity search at each orientation and polarization. This is time consuming and involves retesting the module's received power vs PER curve repeatedly, even though only the antenna gain varies between orientations and polarizations. In accordance with embodiments of the present invention, the measurement of antenna gain variation and module PER vs received power are decoupled. This is achieved by using RSSI measurements to track antenna gain while performing a single point test of module sensitivity. The results are combined through a scaling procedure to obtain the TIS. These embodiments recognize that the only quantity that changes between different orientations in a TIS test is the antenna gain or the combined antenna gain for dual-antenna devices. In these embodiments, the measurement of the gain variation of device antenna 104 with platform orientation is decoupled from the performance of the embedded radio module 106 which remains substantially constant.

The largest fraction of time in a conventional TIS test is taken up by the repeated search for module sensitivity which is generally performed by looping over successively lower transmit powers until a bit-error-rate (BER) or the PER criterion is met. By separating the measurement of the gain variation from the search for module sensitivity, test time is significantly reduced.

In accordance with some embodiments,

1) The gain variation of device antenna 104 may be captured by logging the RSSI reported by the embedded radio module 106 at a fixed reasonably high transmit power, for both antenna polarizations of transmit antenna 122. The transmit power should be high enough to provide a stable connection, even when a null of the device antenna 104 is pointed towards the transmit antenna 122. An assumption of a 30 dB null may be adequate to cover most device antennas 104 used in portable and mobile devices.

2) A single measurement search of the module sensitivity is performed at one reference location and polarization. In some embodiments, reference location and polarization may have the best RSSI from the previous scan, although this is not a requirement.

3) The RSSI reported at the single location (the reference location and polarization) as well as the measured sensitivity at this single point is noted.

4) The total isotropic sensitivity is calculated as a correction to the single point sensitivity. The correction factor may be the difference between the measured single point RSSI and the average RSSI when the fixed high transmit power was used. In these embodiments, the RSSI pattern is the total RSSI pattern and the single point sensitivity measurement may be performed at just one polarization.

The derivation for TIS using RSSI in accordance with some embodiments is presented below. In this derivation, <F>=∫∫F sin(θ)dθdφ is the sine-weighted definite integral of F over a sphere with 0<=θ<=π, 0<=φ<=2π and Δ(Preamble-Data) is a correction due to RSSI being measured over a preamble power and the sensitivity being reported over an un-boosted data power.

### 1) RSSI(θ,φ)=PowerTxHighFixedTx+GainTx−PathLoss+GainRx(θ,φ)

2) RSSI@sensitivity=PowerTx@sensitivity (θref,φref)+GainTx−PathLoss+GainRx(θref,φref)
3) PowerTx@sensitivity(θref,φref)=RSSI@sensitivity−GainTx+PathLoss−GainRx(θref,φref)
4) [symbol] RSSI [symbol] =PowerTxHighFixedTx+GainTx−PathLoss+Efficiency
5) EIS(θ,φ)=PowerTx@sensitivity(θ,φ)+GainTx−PathLoss−Δ(Preamble−Data)=RSSI@sensitivity−GainTx+PathLoss−GainRx(θref,φref)+GainTx−PathLoss−Δ(Preamble−Data)
6) ∴ EIS(θ,φ)=RSSI@sensitivity−GainRx(θref,φref)−Δ(Preamble−Data)
7) [symbol] EIS [symbol] =RSSI@sensitivity−Efficiency−Δ(Preamble−Data)
i.e TIS=RSSI@sensitivity−Efficiency−Δ(Preamble−Data)
Eliminating Efficency between 7) and 4), 8) TIS=RSSI@sensitivity− [symbol] RSSI [symbol] +PowerTxHighFixedTx+GainTx−PathLoss−Δ(Preamble−Data)
Note: [symbol] GainRx [symbol] =Efficiency & [symbol] EIS [symbol] =TIS, where [symbol] [symbol] is used to indicate average over orientations.
9) But, RSSI@sensitivity=PowerTx@sensitivity+GainTx−PathLoss+GainRx(θref,φref)
RSSI@sensitivity is measured at one reference point.
10) And RSSI@HighFixedTx=PowerTx@HighFixedTx(θref,φref)+GainTx−PathLoss+GainRx (θref,φref)
11) ∴ using 9) and 10), RSSI@sensitivity=RSSIθ@HighFixedTx(θref,φref)+(PowerTxθ@sensitivity (θref,φref)−PowerTxHighFixedTx)
(Above Expression Provides Higher accuracy compared to direct measurement
Only quantities that vary with orientation have dependency on (θref,φref) explicitly indicated.)
By substituting for RSSI@sensitivity in 8),
12) TIS=RSSI@HighFixedTx(θref,φref)+(PowerTx@sensitivity(θref,φref)−PowerTxHighFixedTx)− [symbol] RSSI [symbol] . . .

### . . . +PowerTxHighFixedTx+GainTx−PathLoss−Δ(Preamble−Data)

13) TIS=[RSSIθ@HighFixedTx(θref,φref)− [symbol] RSSI [symbol] ]+PowerTxθ@sensitivity(θref,φref)+GainTx−PathLoss−Δ(Preamble−Data)
14) i.e TIS−EIS(θref,φref)=[RSSIθ@HighFixedTx(θref,φref)− [symbol] RSSI [symbol] ]

5) The effective isotropic sensitivity (EIS), which describes the measured over the air sensitivity at one orientation, may be estimated for any random orientation from just one reference sensitivity measurement, with the appropriate correction factors being applied similar to TIS calculation. This may be described by the following equation:

EIS(θ_{new},φ_{new})=└RSSI_{@HighFixedTx}(θ_{ref},φ_{ref})−RSSI_{@HighFixedTx}(θ_{new},φ_{new})┘+Power_{Tx}_{_{@sensitivity}}(θ_{ref},φ_{ref})+Gain_{Tx}−PathLoss−Δ_{(Preamble-Data)}

This formalism makes the relationship between the antenna pattern and the radiated sensitivity pattern clear as one based on an inversion transformation.

For example:

TIS=RSSI_{@sensitivity}−Efficiency−Δ_{(Preamble-Data)}

TIS=const−Efficency

While

[symbol]

RSSI [symbol] =Power_{Tx}_{_{HighFixedTx}}+Gain_{Tx}−PathLoss+Efficiency

[symbol]

RSSI [symbol] =Const2+Efficiency

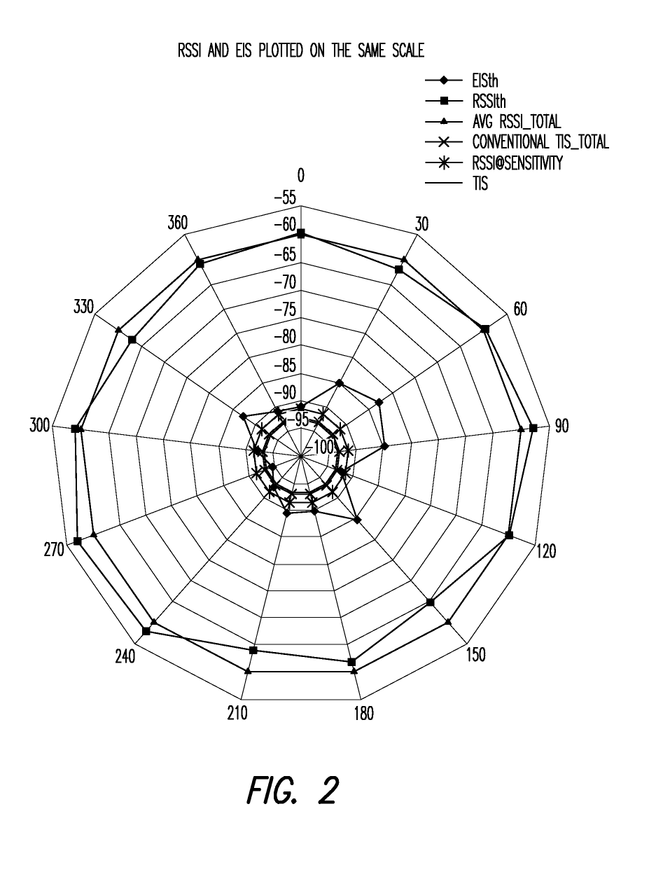

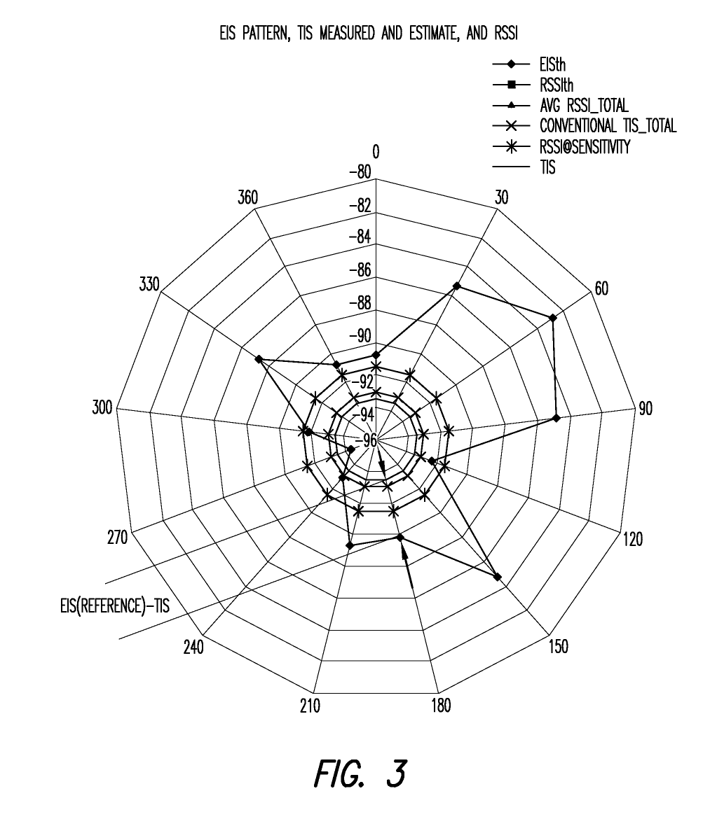

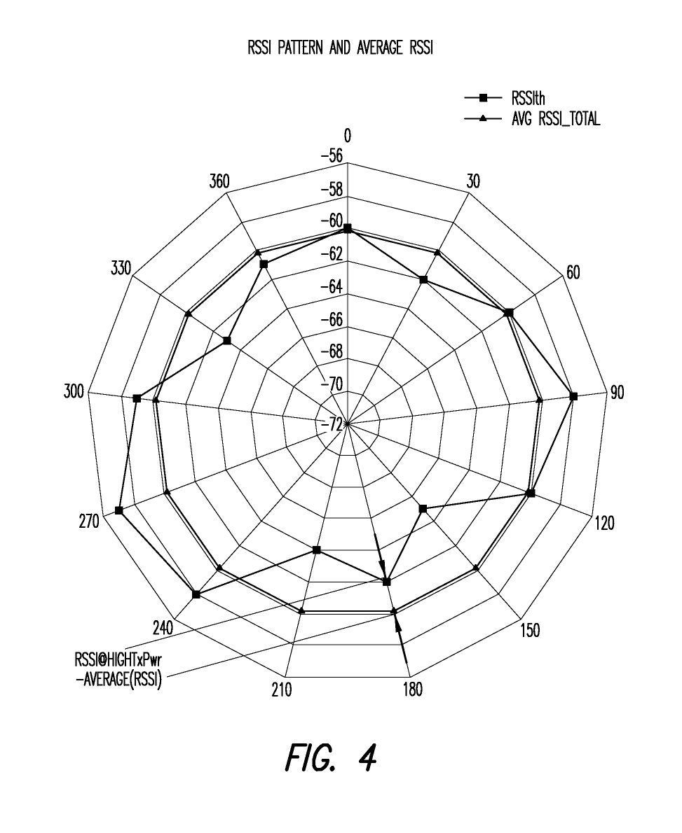

FIG. 2 illustrates examples of RSSIs and EIS measurements in accordance with some of these embodiments. FIG. 3 illustrates an EIS pattern, the measured and estimated TIS, and the RSSIs in accordance with these embodiments. FIG. 4 illustrates an RSSI pattern and an average RSSI in accordance with some of these embodiments.

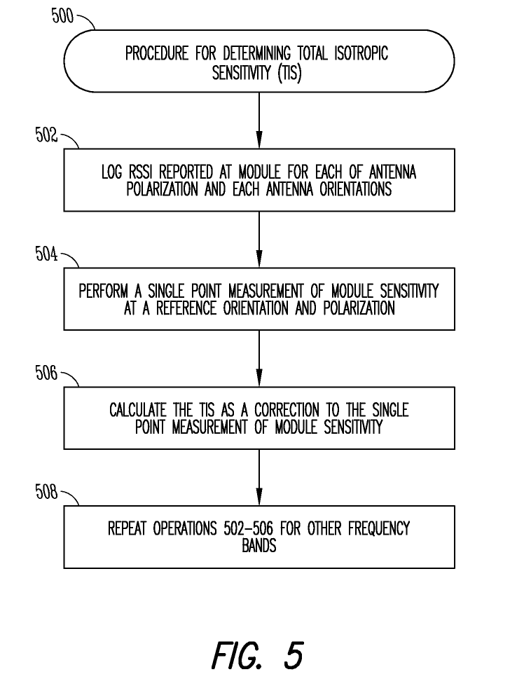

FIG. 5 is a procedure for determining TIS in accordance with some embodiments. Procedure 500 may be performed by a test station or testing setup, such as test station 100 (FIG. 1) although other testing stations and test setups may also be used.

Operation 502 includes logging the RSSI reported at the embedded radio module 106 (FIG. 1) for each of a plurality of polarizations of transmit antenna 122 (FIG. 1) and for each of a plurality of orientation of the platform (i.e., orientations of wireless broadband client device 102 (FIG. 1)). Operation 504 includes performing a single point measurement of module sensitivity at a reference orientation and a single polarization of the transmit antenna 122. Operation 506 includes calculating the TIS as a correction to the single point measurement of module sensitivity. The correction factor to correct the TIS is based on a difference between an average of the logged RSSI measurements and an RSSI at the reference orientation and polarization. The single point measurement of module sensitivity at the reference orientation and polarization may include stepping down a transmit power level of the base station emulator 128 (FIG. 1) and monitoring the PER at each of the stepped-down transmit power levels until the PER falls below a predetermine threshold.

In some embodiments, operation 502 may include first establishing a connection between the base station emulator 128 and the embedded radio module 106 at one frequency. A list of frequencies may be stored in the embedded radio module 106 and the module may scan for that which is active to establish a connection. The platform may be rotated to different orientations and an RSSI reading may be taken for each polarization of transmit antenna 122 (e.g., one reading for horizontal polarization and one for vertical polarization signal). These RSSI values may be conveyed to the control software on the base station emulator 128 via the GPIB or LAN connection. In these embodiments, the transmit antenna 122 may be configured to receive signals from the platform including the RSSIs over a bi-directional link. In these embodiments, the test setup system 100 may include a processing element and a memory element within control computer 132 to perform the various operations involved with determining the TIS. Some of these embodiments may also be implemented as instructions stored on a computer-readable medium.

In some embodiments, the orientations range from 0 to 180 degrees in elevation and 0 to 360 degrees in azimuth, with a step size that may range from 30 degrees to 5 degrees. In some embodiments, a 30 degree scan may be used, although this is not a requirement. Elevation may be defined as rotation about the vertical axis and azimuth may be defined as rotation about the horizontal axis as illustrated in FIG. 1 with arrows.

Embodiments may be implemented in one or a combination of hardware, firmware and software. Embodiments may also be implemented as instructions stored on a computer-readable medium, which may be read and executed by at least one processor to perform the operations described herein. A computer-readable medium may include any mechanism for storing in a form readable by a machine (e.g., a computer). For example, a computer-readable medium may include read-only memory (ROM), random-access memory (RAM), magnetic disk storage media, optical storage media, flash-memory devices, and other storage devices and media.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method of determining total isotropic sensitivity (TIS) of a wireless broadband client device comprising a device antenna and an embedded radio module, the method comprising:
logging a received signal strength indicator (RSSI) reported at the radio module for each of a plurality of antenna polarizations of a transmit antenna and for each of a plurality of platform orientations;
performing a single point measurement of module sensitivity at a reference orientation and polarization; and
calculating the TIS as a correction to the single point measurement of module sensitivity,
wherein a correction factor to correct the TIS is based on a difference between an average of the logged RSSIs and an RSSI at the reference orientation and polarization.

2. The method of claim 1 wherein performing the single point measurement of module sensitivity at the reference orientation and polarization comprises:
stepping down a transmit power level of a base station emulator 128; and
monitoring a packet-error-rate (PER) at each of the stepped-down transmit power levels until the PER falls below a predetermine threshold.

3. The method of claim 2 wherein the reference orientation and polarization are selected from a highest of the logged RSSIs and a single polarization of the transmit antenna.

4. The method of claim 3 wherein a fixed high transmit power is used for measuring the RSSIs,
wherein the radio module is configured to analyze signals received through the device antenna to determine the RSSIs, and
wherein the logging of the RSSIs captures gain variation of the device antenna.

5. The method of claim 4 further comprising repeating the logging of RSSIs, performing the single point measurement of module sensitivity, and the calculating the TIS for each of a plurality of frequency bands.

6. The method of claim 5 further comprising estimating an effective isotropic sensitivity (EIS) for at least some of the platform orientations by applying another correction factor to the single point measurement of module sensitivity and the RSSIs.

7. The method of claim 6 wherein the method is part of performing a TIS test for certification of the wireless broadband client device for a wireless broadband standard.

8. The method of claim 7 wherein the radio module is a WiMAX module configured to operate in accordance with an IEEE 802.16 standard.

9. The method of claim 7 wherein the radio module is an LTE module configured to operate in accordance with an 3rd Generation Partnership Project (3GPP) Universal Terrestrial Radio Access Network (UTRAN) Long-Term-Evolution (LTE) standard.

10. The method of claim 7 wherein the module is configured to operate in accordance with a third-generation (3G) high-speed packet access (HSPA) standard.

11. A test setup system configured to determine a total isotropic sensitivity (TIS) of a wireless broadband client device comprising a device antenna and an embedded radio module, the test setup system comprising a processing element and a memory element configured to:
log a received signal strength indicator (RSSI) reported at the radio module for each of a plurality of antenna polarizations of a transmit antenna and for each of a plurality of platform orientations;
perform a single point measurement of module sensitivity at a reference orientation and a single polarization of the transmit antenna; and
calculate the TIS as a correction to the single point measurement of module sensitivity,
wherein a correction factor to correct the TIS is based on a difference between an average of the logged RSSIs and an RSSI at the reference orientation and polarization.

12. The test setup system of claim 11 wherein to perform the single point measurement of module sensitivity at the reference orientation and polarization, the test setup system is configured to:
step down a transmit power level of a base station emulator; and
monitor a packet-error-rate (PER) at each of the stepped-down transmit power levels until the PER falls below a predetermine threshold.

13. The test setup system of claim 11 wherein the reference orientation and polarization are selected from a highest of the logged RSSIs and a single polarization of the transmit antenna,
wherein the radio module is configured to analyze signals received through the device antenna to determine the RSSIs,
wherein the test setup system includes a base station emulator 128 configured to transmit a fixed high transmit power is used for measuring the logged RSSIs, and
wherein the logging of the RSSIs captures gain variation of the antenna.

14. The test setup system of claim 13 further comprised to repeat the logging of RSSIs, performing the single point measurement of module sensitivity, and the calculating the TIS for each of a plurality of frequency bands.

15. The test setup system of claim 14 further configured to estimate an effective isotropic sensitivity (EIS) for at least some of the platform orientations by applying another correction factor to the single point measurement of module sensitivity and the RSSIs.

16. A computer-readable storage medium that stores instructions for execution by one or more processors to perform operations for determining a total isotropic sensitivity (TIS) of a wireless broadband client device, the operations comprising:
logging a received signal strength indicator (RSSI) reported at a radio module for each of a plurality of device antenna polarizations and for each of a plurality of platform orientations;
performing a single point measurement of module sensitivity at a reference orientation and polarization; and
calculating the TIS as a correction to the single point measurement of module sensitivity,
wherein a correction factor to correct the TIS is based on a difference between an average of the logged RSSIs and an RSSI at the reference orientation and polarization.
